(19) United States
(12) Patent Application Publication
(10) Pub. No.: US 2004/0111428 A1
(43) Pub. Date: Jun. 10, 2004

(54) Toolset for applying object-oriented models to multi-tiered enterprise applications

(75) Inventors: Surya Rajan, Houston, TX (US); Britt S. Poulsen, Missouri City, TX (US); Carl Patrick Seaton, Sugar Land, TX (US); Kim Liew, Houston, TX (US); Sankar Subbiah, Houston, TX (US)

Correspondence Address: BAKER BOTTS, LLP, 910 LOUISIANA, HOUSTON, TX, 77002-4995, US

(73) Assignee: Marathon Ashland Petroleum LLC

(21) Appl. No.: 10/313,297

(22) Filed: Dec. 6, 2002

(51) Int. Cl. G06F 7/00

(52) U.S. Cl. 707/102

(57) ABSTRACT

An apparatus, system and method are provided for generating relationships between client objects, business objects, external objects, and a persistence mechanism such as a database that model an enterprise application. The apparatus and system are thus a set of tools that can be used by a developer or other user to facilitate the development of enterprise business applications. The database tool generates code for correlating business, client, external, and other specifications. Object inheritance, collections, and other object-related issues are accommodated by the present invention. A deployment tool performs all of the logical steps necessary to move code (or binaries) from one environment to another, such as from a development environment to a production environment. Finally, a proxy tool generates one or more proxies and other handler objects.

### CROSS-REFERENCE TO RELATED APPLICATIONS

This application is related to U.S. patent application Ser. No. 10/190,891 entitled “OBJECT ORIENTED SYSTEM AND METHOD FOR PLANNING AND IMPLEMENTING SUPPLY CHAINS” by Magers, et al., that was filed on Jul. 8, 2002; and provisional application serial No. 60/421,971 entitled “GENERIC FRAMEWORK FOR APPLYING OBJECT-ORIENTED MODELS TO MULTI-TIERED ENTERPRISE APPLICATIONS,” by Rajan, et al., that was filed on Oct. 29, 2002, and which are incorporated herein by reference, in their entirety, for all purposes.

### BACKGROUND OF THE INVENTION TECHNOLOGY

1. Field of the Invention

The present invention is related to multi-tiered enterprise applications. More specifically, the present invention is related to a set of tools for facilitating the creation of multi-tiered software implementations of models that simulate enterprise operations, and the frameworks used to create the multi-tiered software.

2. Description of the Related Art

Current multi-tiered enterprise application management tools typically model one of the elements of a multi-tiered enterprise application, such as a supply chain, or other business endeavor. For example, some supply chain systems focus on the transport of the commodity. Other modeling systems focus on the contract formation; others on collaboration or messaging. Still others concentrate on the scheduling. Other types of multi-tiered enterprise applications include banking applications (linking banks to customers), a personnel system (employees to companies), or any other system that links one or more elements of one business enterprise to another enterprise, or another element within the same enterprise. Such enterprise applications allow companies to:

1. Streamline their internal processes;

2. Link with their supply chains;

3. Link with their customers; and/or

4. Create new products quickly and that are mass-customized.

Sun Microsystems of Mountain View, Calif., and Microsoft Corporation of Redmond, Wash., both are key players in enterprise software development. Sun introduced ENTERPRISE JAVA BEANS (“EJB”) that provides a server-side component architecture. Third-party companies build Transaction Servers conforming to Sun's architecture. Thereafter, Microsoft introduced COM+. COM+ is not an architecture. Rather, COM+ is a Transaction Server. Enterprise software that is written for COM+ can avail itself of COM+ services.

When building a new enterprise system, the choice between Common Object Request Broker Architecture (“CORBA”), Enterprise Java Beans (“EJB”) and the extension to the common object model (“COM+”) is difficult. EJB provides a server-side architecture. The EJB server-side architecture specifies how business objects are organized and how a business object can access Transaction Server services. COM+ is a more low-level methodology that was developed by the Microsoft Corporation of Redmond, Wash. COM+ simply provides services, information about which is available at http://www.microsoft.com/com/wpaper/default.asp#COM+ papers. Under the COM+ regime, how business objects are organized is left to the enterprise architecture team. However, what COM+ does offer is integration with other Microsoft software, such as MICROSOFT OFFICE and INTERNET EXPLORER, manufactured by the Microsoft Corporation of Redmond, Wash. Due to its monopoly position on the desktop, integration with Microsoft software is a compelling reason to use COM+. Therefore, a need has developed in the industry for an enterprise architecture that is compliant with COM+ yet not simply a server-side architecture as in the case of EJB. Instead, there is a need for an architecture that encompasses all tiers of an enterprise system. Specifically:

1. Client-side;

2. Server-side;

3. Database; and

4. External (such as two-way access to external applications and external data).

The desired architecture would comprise an end-to-end solution for enterprise system development. The need exists for a solution that allows the enterprise system to keep up with the changes in business models and communication capabilities. The desired solution would also perform well, would be scalable, preferably clustered, and would contain other features that are characteristic of a robust enterprise system.

Tools for generating multi-tiered enterprise applications are also lacking. As the greatest value that can be added is the implementation of tailored multi-tiered enterprise software models to current conditions, a premium is placed on the ability to generate models quickly to respond to changes to market conditions.

In the late 1990's, the software industry attempted to overcome the shortcomings of the client-server implementation model with components and frameworks. A component can be defined as a language-neutral, independently implemented package of software services that are delivered in an encapsulated and replaceable container. The component is accessed through one or more published interfaces. Ideally, the component is not platform specific (i.e., it is not constrained to any hardware architecture) nor is it bound to a particular software application environment. In contrast, a framework can be defined as a set of cooperating software classes that make up a reusable design for a specific class of software. A framework provides architectural guidance by partitioning the design into abstract classes and defining their responsibilities and collaborations. A developer can customize the framework to a particular application by sub-classing and composing instances of framework classes.

Recent advances in Rapid Application Development (“RAD”) software enable the modeling of objects quickly. One current RAD solution is Enterprise Java Beans (“EJB”), which is a specification that is available at http://java.sun.com/products/ejb/docs.html. While EJB has certain desirable characteristics, the EJB technology does not:

1. Provide a mechanism for the mass production of client forms. One can build client forms that work with EJB, of course. However, EJB does not provide a mechanism for mass producing client forms.

2. RAD integration of the middle and data tiers. The middle and data tiers in enterprise software applications are tightly coupled. However, previously, there had been no RAD mechanism for coupling the two such that:

a. There is compile-time checking between them.

b. They exhibit high performance.

c. They are consistent (naming conventions, etc.).

3. Heterogeneous application integration. EJB does not provide a way for the middle tier to talk to heterogeneous applications such that:

a. There is compile-time checking between them.

b. They are consistent (naming conventions, etc.)

4. Provide advanced business object features. Features such as:

a. Business inheritance among business objects.

b. Business objects capable of automatically converting into other business objects.

c. Advanced error support. EJB vendors are one of the few that can capture operating system exceptions. However, they do not display the entire call stack including line numbers when errors are found.

5. Transaction Server independence. One can only debug/test an EJB application from inside EJB. That means one must deploy their business components into the EJB container. This time-intensive activity is not necessary with the present invention. The present invention will run the same (transactionally) whether inside a transaction server or not.

6. Provide a mechanism for the mass production of client forms. One can build client forms that work with EJB, of course, however they do not provide a mechanism for mass producing these forms.

7. RAD integration of the middle and data tiers. The middle and data tiers in enterprise applications is tightly coupled. However, previously, there had been no RAD mechanism for coupling the two such that:

a. There is compile-time checking between them.

b. They are of high performance caliber.

c. They are consistent (naming conventions, etc.).

8. Heterogeneous application integration. EJB does not provide a way for the middle tier to talk to heterogeneous applications such that:

a. There is compile-time checking between them.

b. They are consistent (naming conventions, etc.)

9. Provide advanced business object features. Features such as:

a. Business inheritance among business objects.

b. Business objects capable of automatically converting into other business objects.

c. Advanced error support. EJB vendors are one of the few that can capture operating system exceptions. However, they do not display the entire call stack including line numbers when errors are found.

10. Transaction Server independence. One can only debug/test an EJB application from inside EJB. That means one must deploy their business components into the EJB container. This is a time-intensive activity.

Consequently, because of the shortcomings of EJB, the industry has needed a way to have an overall synergistic framework, where all of the constituent parts act as one. This synergistic framework would have RAD through all tiers and high performance throughout. A desirable RAD system would also have an enforced mechanism and have a consistent naming convention for the constituent parts. In addition, a desirable RAD system would facilitate code reuse and provide an end to end solution that models correctly current multi-tiered enterprise applications, such as supply chains and potential supply chains that have disparate business models.

Frameworks, however, require tools to enable users to employ the frameworks more easily. If frameworks are easy to use, then the framework will be employed. Otherwise, if frameworks require a steep learning curve, or impart additional encumbrances, the framework will not be used by developers and the potential benefits of the framework will not be realized. There is therefor, a need in the art for a system and method for tools that facilitate the use of frameworks that generate multi-tiered enterprise models that can be used to manage existing multi-tiered enterprise applications, e.g., supply chains, or to develop new models that are optimized to the problem and/or market at hand.

### SUMMARY OF THE INVENTION

The present invention provides an apparatus, system and method for generating relationships, typically in the form of computer code, between client objects, business objects that model an enterprise application, database that stores the information for those business objects, and external objects. The apparatus and system are thus a set of tools that can be used by a developer or other user to facilitate the development of enterprise business applications. The database tool generates code for correlating business specifications in the form of business objects to a database schema. Object inheritance, collections, and other object-related issues are accommodated by the present invention. A deployment tool performs all of the logical steps necessary to move code (or binaries) from one environment to another, such as from a development environment to a production environment. Finally, a proxy tool generates one or more proxies and other handler objects.

The toolset has three basic components: a database wizard, a deploy wizard, and a proxy wizard. The database and proxy wizard generate code for use with a framework or an enterprise application. The deploy wizard is used to deploy code (such as code generated by the other two wizards, and/or code provided by one or more developers) to various servers and clients for implementation and/or production.

The database wizard is used for one or more of the following functions: generating database business objects code; generating business object code; generating client code; generating one or more stored procedures; generating one or more report files; generating one or more extensible schema definition files; generating one or more batch files; starting a build process; enforcing one or more naming conventions; and/or enforcing one or more database schema conventions.

The deploy wizard is used for one or more of the following functions: creating a directory structure; copying one or more files; registering one or more files; configuring one or more components; creating a CAB file; comparing one or more binaries to requisite versions and, if necessary, updating the binary to the requisite version; and modifying one or more HTML pages. The deploy wizard facilitates the deployment of code and components into a production environment.

The proxy wizard is used for one or more of the following functions: generating one or more proxies; and generating one or more handlers. The proxies are used to enforce security and/or transactional requirements. The handlers are used for outgoing calls from clients.

The toolset of the present invention can be used with or without a framework. A suitable framework can include a transaction server, a business framework, a database and accompanying database framework. Additional frameworks can be added, such as an external framework for working with outside processes, as well as clients and client frameworks.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a screenshot of the information dialog of the tool displaying general information according to the teachings of the present invention.

FIG. 2 is a screenshot of the information dialog of the tool displaying business database schema feature according to the teachings of the present invention.

FIG. 3 is a screenshot of the information dialog of the tool displaying business object generation according to teachings of the present invention.

FIG. 4 is a screenshot of the information dialog of the tool displaying client information according to the teachings of the present invention.

FIG. 5 is a screenshot of the information dialog of the tool displaying business database tables and views according to the teachings of the present invention.

FIG. 6 is a screenshot of a second information dialog of the tool displaying build information according to the teachings of the present invention.

FIG. 7 is a block diagram illustrating the relationship with a handler of the client framework and the PxBus of the business framework according to the teachings of the present invention.

FIG. 8 is a block diagram illustrating a deployment according to the teachings of the present invention.

FIG. 9 is a block diagram illustrating a framework with a database wizard according to the teachings of the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention, as defined by the appended claims, are to be covered.

### DETAILED DESCRIPTION OF SPECIFIC EMBODIMENTS

Overview

In order to provide an end to end enterprise application solution, tools such as frameworks and specialized developer tools are often needed. There are three specialized tools used within a comprehensive solution of the present invention:

1. A DatabaseWizard, a code generator;

2. A DeployWizard, which performs all logic necessary to move binaries from one environment to another; and

3. A ProxyWizard that generates proxies and Handler objects.

Each of these specific tools of the toolset of the present invention are discussed in detail below.

The DatabaseWizard

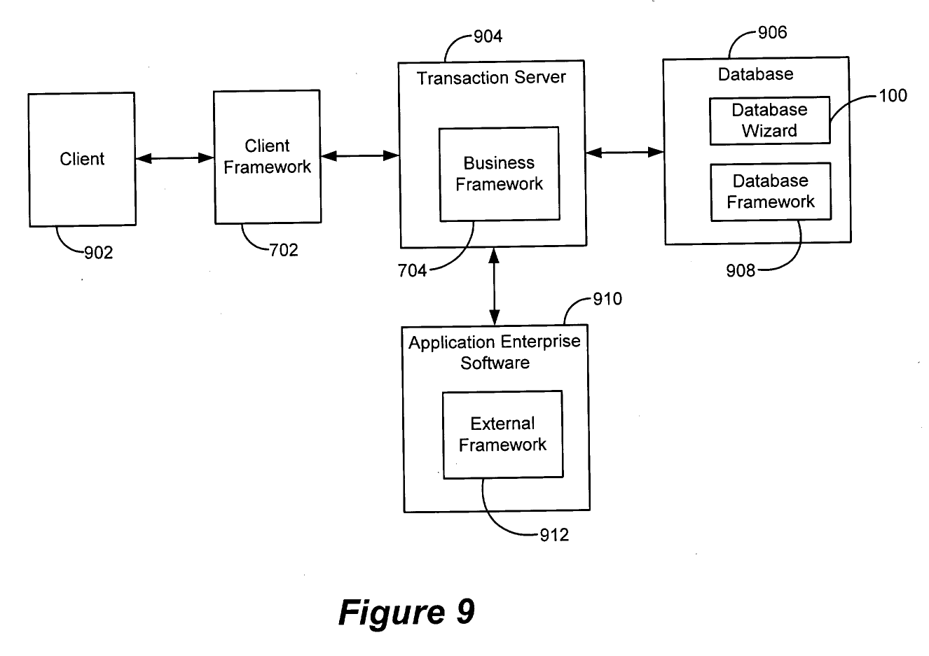

The DatabaseWizard 100 is a code generator that facilitates the creation and linking of business objects of an enterprise application to a database 906 (see FIG. 9) in order to make the business objects persistent. The DatabaseWizard 100 also facilitates the creation and the linking of client objects to business objects, and business objects to the external framework 912 (see FIG. 9). In addition to persistence, the DatabaseWizard 100 of the present invention can also facilitate the retention of other information related to the enterprise application on the database. In the preferred embodiment of the present invention, use of the DatabaseWizard 100 is mandatory, although it need not be mandatory in alternate embodiments of the present invention. The DatabaseWizard 100 works best, however, when it is an integrated part of the development cycle.

The DatabaseWizard 100 makes the building of components a rapid application development (“RAD”) process. Moreover, the DatabaseWizard 100 also enables the building of the framework itself to be a RAD process because much of the framework is located in generated code. By changing the DatabaseWizard 100, the developer can change all the code generated within the framework and thus affect the code generated by the framework. Consequently, developers can quickly and easily add new functionality, enhancements, bug-fixes, etc. to business objects.

An illustrative framework that can be used in conjunction with the DatabaseWizard 100 is illustrated in FIG. 9. Referring to FIG. 9, a transaction server 904 contains a business framework 704 that interacts with one or more clients 902 via the client framework 702. The database 906 contains the database framework 908 and the DatabaseWizard 100 as illustrated in FIG. 9. Additional (optional) elements include the application enterprise software 910 and an external framework 912.

It is important to remember that the code generated within the framework is not just generated once. The generation of code is part of the build cycle itself. Code is generated before a build begins. Consequently, the framework-generated code is essentially generated dynamically. If the DatabaseWizard 100 is changed, for example, such that all code now includes a Foo( ) function, then upon next build, all developer code (i.e., code not generated by the framework) will have a Foo( ) function. Later, the DatabaseWizard 100 may change again such that a Foo2( ) function is generated. Once rebuilt, all of the developers can access the new Foo2( ) function. Moreover, the DatabaseWizard 100 also generates environment files (such as build batch files, etc.) that are dynamically generated as well.

The DatabaseWizard 100 allows the framework to be extensible easily. For example, the developers may want to be able to store all of the database-persistent parameters for a business object in a collection, based on an array rather then a collection based on a linked list. The DatabaseWizard 100 graphical-user-interface (“GUI”) would change to have a new checkbox. If this new checkbox is checked, then another business object would be generated, and the new business object would be bound to an array.

The present invention also facilitates ease-of-change for project files as well as the basic objects. The project files are not normally kept in a software version-control-system, and are in fact generated dynamically. Consequently, by changing the way that the DatabaseWizard 100 generates the project files, a developer can change all of the project files for all of the business objects without having to manually change each one individually.

When code is generated via the DatabaseWizard, the DatabaseWizard 100 writes information about the business object to a persistence mechanism that ideally would be an information (“INI”) file. The DatabaseWizard 100 uses the information in the INI file during the build cycle to determine which business objects to generate, and how to generate them.

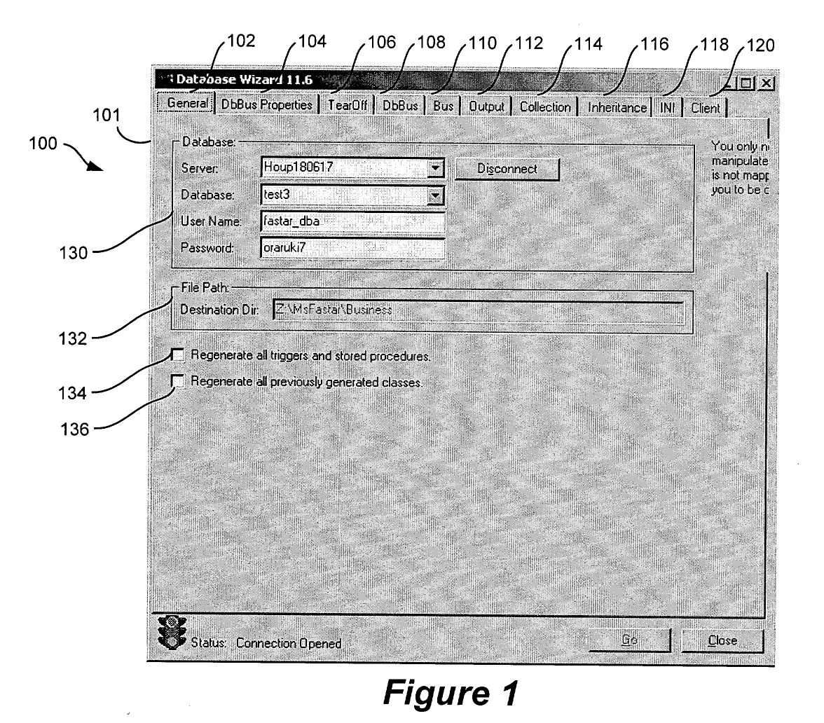

A graphical user interface of a DatabaseWizard 100 is illustrated in FIG. 1. This embodiment of the DatabaseWizard of the present invention is merely illustrative, and there are many ways to implement the functionality of the present invention, either by modifications to the GUI, by text-based communication, or other means. In the illustrative embodiment of FIG. 1, the DatabaseWizard 100 has a client interface 101 with several tabs that enable the user to seek specialized functionality. The tabs are generally categorized according to function, whatever that function may be. For example, there is a general information tab 102 having user-interface components (widgets) 130, 132, 134, and 136. The user-interface components enable the user/developer to affect parameters of the DatabaseWizard 100 that are used to generate code. The various tabs 102-120 have similar user-interface components for the various functions of the DatabaseWizard 100. Typical user-interface widget components are edit boxes, combo boxes, radio buttons, check boxes and the like. The types of widgets used can be specific to the window manager (and/or operating system) and others may be cross-platform.

In the preferred embodiment of the present invention, the DatabaseWizard 100 is capable of several functions, namely:

1. generating database business object (“DbBus”) code;

2. generating business object (“Bus”) code;

3. generating client (interface) code;

4. generating stored procedures;

5. generating report writing (“TTX”) files;

6. generating XML Schema Definition (“XSD”) files;

7. generating batch files;

8. participating in the build process;

9. enforcing naming conventions; and/or

10. enforcing database schema conventions.

Generating Database Business Object (DbBus) Code

A DbBus object is a business object that has at least a database-specific or an external-specific aspect that is connected to a particular table or to a particular view in a database 906, or to an external system (not shown). The typical DbBus business object consists of a database-persistent parameter, or an external-persistent parameter, called “DbData”. A collection of DbDatas, where the iterating algorithm is a linked list, is represented by a CollDbdata object. If the iterating algorithm is a map (hash), a MapDbData object is used. Other iterating algorithms can be added as needed.

The database 906 of the present invention can be a relational database having elements including, but not limited to, tables and views. The database 906 of the present invention can alternatively be an object database, wherein the elements of the object database 906 would be objects. In yet another alternate embodiment, the database 906 could be an object-relational database that stored object information (such as class, property values, etc.) in rows and columns of various tables while presenting the information as an object when queried. Object-relational databases 906 require a mapping function to translate the stored relational information into objects upon request. The necessary mapping can be accomplished with the object-relational database's own internal mapping routines, or it may be supplied by an intermediate process by the user or a third party.

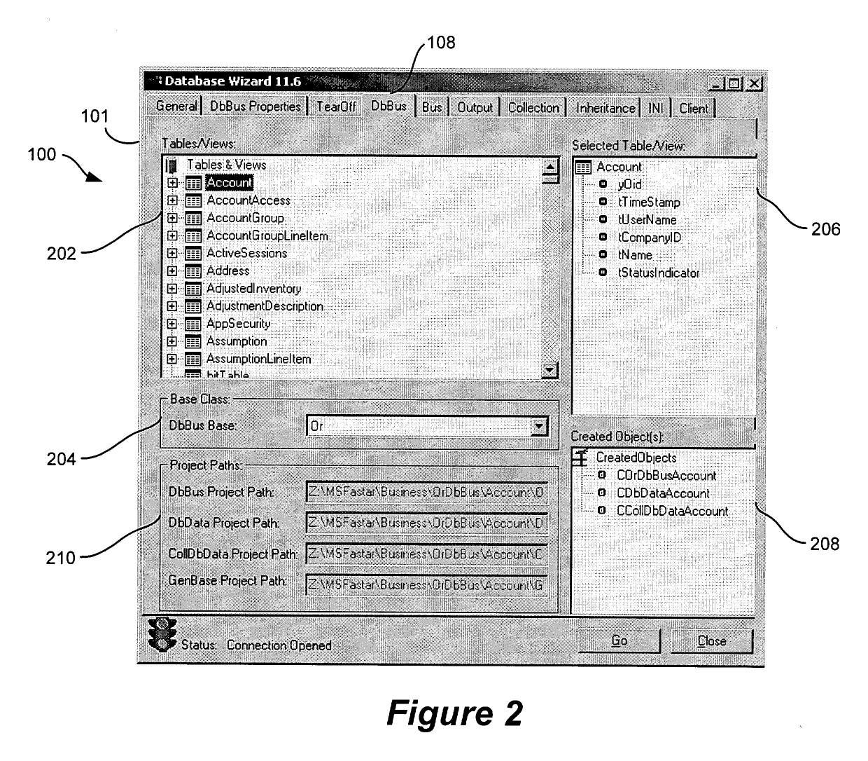

FIG. 2 illustrates the DbBus-particular parameters for the DatabaseWizard 100. Referring to FIG. 2, the DatabaseWizard 100 is represented by GUI 101 at tab 108. The tab 108 presents a table/views locator 202, nominally illustrated with the tree-view widget. Specifics about the selected table or view are illustrated in tree-view 206. The base class or organizational group from which the specific database business (DbBus) object will be derived is designated with the pull-down menu 204 of the graphical user interface 101. Path (file-system) information can be designated in the various edit boxes of group 210. The various types of DbBus objects that are created by the DatabaseWizard 100 are illustrated in the tree-view box 208.

DbBus business objects are generated from tables and views in the database 906. Each business object component inherits from a generated base class. The DatabaseWizard 100 generates two types of code:

1. Generated Base Code. This code is placed in a special folder in the business object's directory. Every time that a build is done, the generated base code will be overwritten. This makes it useless for developers to change generated code and makes it possible for business objects to dynamically inherit, for example, new functionality, bug-fixes, etc. More importantly, overridden generated base code enables compile-time checking of database schema to code. For example, assume a database table has a column called volume. When the business object is generated for this table, the database-persistent parameter will have a method called get_Volume and put_Volume. Other business objects then use these methods. If the database table then changes such that it does not have the volume column, then on subsequent regeneration, the base class will be missing the get_Volume, put_Volume methods. The other business objects that use this method now find it missing and thus those other business objects do not compile.

2. Generated Derived Code. Developers are allowed to modify generated derived code. If developers modify generated derived code, the code will not be overwritten on subsequent builds.

Generated DbBus objects are fully functional and are capable of compilation without modification. All project files (make files, etc.) associated with the newly generated DbBus objects are generated as well. Consequently, a developer merely creates a table and then, after generating objects from the table, other business objects can modify the entries in the table via the generated business object.

In the preferred embodiment, generated DbBus objects gain at least the following features: automatic cloning; automating CloneNew; automatic generation of “get” and “put” methods; status flags; support of primitive types; automatic generation of state types; business inheritance (apart from code inheritance); object metamorphosis; and change history.

Automatic Clone.

In the preferred embodiment of the present invention, when business objects are generated, they automatically receive the ability to create copies of themselves. Remember that a business object can consist of persisted and non-persisted values. The persisted values are automatically included in a business object at the time they are generated. The non-persisted values must be added manually by a developer. When a business object is cloned, both the non-persisted values and the persisted values are cloned. Moreover, the business object's status flags are also cloned.

Automatic CloneNew

The CloneNew feature of the present invention allows business objects to create a copy of themselves. However, instead of a complete clone with the “parent's” status flags being copied to the clone, the status flag is reset such that the clone is marked as being a new object. This allows a business object to insert multiple copies of the same record into the database 906 with each copy having a different (unique) primary key. Although use of a primary key is desirable in the preferred embodiment, use of a primary key is optional.

Automatic “Get” and “Put” Method Generation

When a business object is generated with the DatabaseWizard 100, the business object automatically contains all of the persistent data (values). Functions for affecting the persisted data (such as the prototypical “get” and “put” methods) are automatically created by the DatabaseWizard 100.

Status Flags

Each database-persistent parameter or external-persistent parameter has a status flag. This indicates whether the database-persistent parameter is brand new, unchanged, to be deleted, or changed. The status flag is set automatically by the client framework 702 when the user presses the “New” button, “Delete” button, “Save” button, etc. The client developer need not intervene in the setting of the status flag. Thereafter, when the database-persistent parameter travels back to the business server, then a specialized database business object (“UsDbBus”) can inspect the status flag to determine what should be done. For instance, if the status flag is set to “DELETED,” then the UsDbBus object can delete the object from the database 906. The preferred embodiment of the present invention provides a helper function to further assist the developer. The helper function is called “Process.” When a whole collection of database-persistent parameters are passed to the Process routine, the Process routine will inspect the status flag of each database-persistent parameter. The Process routine will then perform the proper operation (e.g., insert into the database 906, update the database 906, etc.) with the database-persistent parameter (or the external-persistent parameter) given the object's status. The Process routine is generated and thus available to any developer who wishes to use it.

Primitives Support

The database 906 can also contain tables having columns that could include the following special types: a Primary Key; a Calendar; Units; database Indicator; and Binary File. The DatabaseWizard 100 generates wrapper objects for each of the special types noted above. The Primary Key special type is of the kind typical for use as a primary key for the database engine in question. The Calendar type is one that can store time-related information, such as a date, a day, a time, or a combination thereof. The Units type is for handling units of measure, such as dollars, kilograms, barrels, etc. Normally, the Units type is composed of two columns in the database, one having a float type for the actual number of units, and a string column designating the particular unit (such as pounds, liters, etc.). The Binary File type contains information in a binary (i.e., non-ASC11) format. Information in a Binary File type can include binary executables (software programs) and other non-ASC11 formatted documents such as MICROSOFT® WORD documents, the program which is available from the Microsoft Corporation of Redmond, Wash.

The database Indicator type is typically a string column of a table in the database 906. The Indicator type is used to store the name of a particular enumerated value. The Indicator type is useful for storing within the database 906 a human-readable names of values that are used by the present invention. It is well known that comparisons and operations of integer values are much faster than comparisons and operations of character strings. However, the integer values are often cryptic to users who browse the database because their meaning is not easily discerned without resort to a look-up table. To remedy this problem, the names of the enumerated values (such as “RECEIPT” and “DELIVERY” or “R” and “D”) are stored as English words (or characters) in the database 906 within the Indicator types. However, upon retrieval, the string values retrieved from the database 906 are converted to integer (or other) values, e.g., the string “RECEIPT” is converted to the value “0” and DELIVERY is converted to “1”. The Indicator types thus perform the same type of correlation as a constant declaration in Pascal, or an enum declaration in C++.

The wrapper objects that are generated by the DatabaseWizard 100 allow enhanced functionality of the special types mentioned above. For example, the wrapper for a Calendar type can be enabled to add a day to the value in question. Similarly, the wrapper objects generated by the Database Wizard 100 allow for the conversion of a unit of measure from the English system to the metric system to a Unit special type. When a business object is generated from a database table that contains one or more of the special types, the wrapper object is included in the business object, not the raw special type. Consequently, in the example above, the unit object would be included in the business object instead of not two strings variables and a float variable. The business framework 704 will then ensure that the two string variables and the float variable are placed into the unit object.

Automatically Generated State Objects

When a business object is generated from a table or view of the database 906, three objects are actually generated: the business object (DbBus); the business object state (“DbData”); and a collection of the business object states (“CollDbData” persistent parameter).

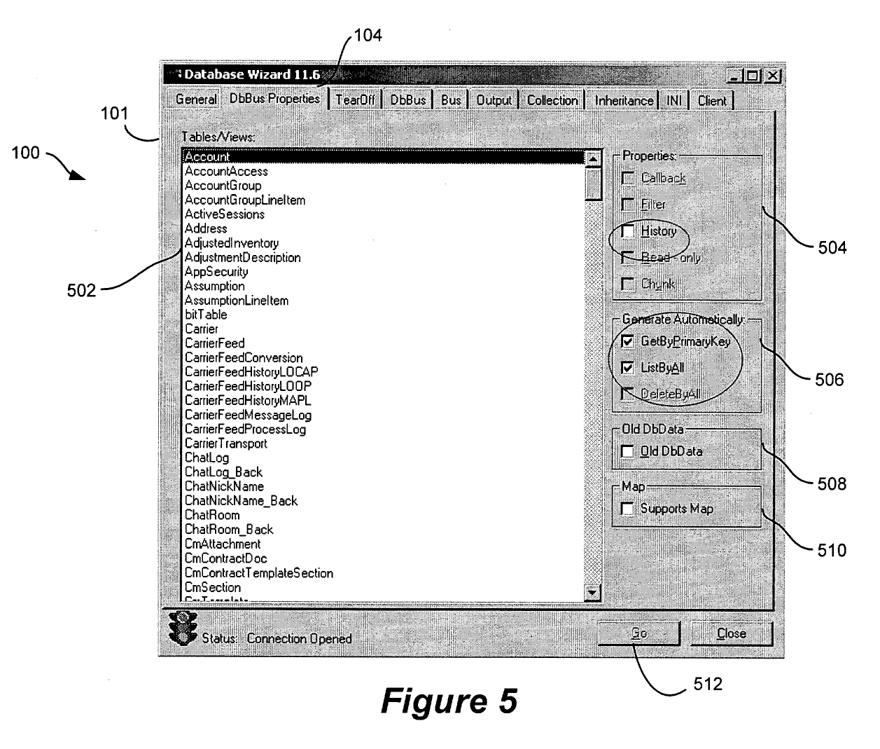

The CollDbData-persistent parameter contains the state of the business object in, for example, a linked list. Linked lists are most efficient at retrieving records sequentially. However, a developer may know a priori that retrieving records sequentially is not necessary in some situations. Rather the list will be used for locating specific records. In that case, the developer may elect to use a Map (sometimes called a hash table). If the developer desires to use a Map, the developer may click the map checkbox 510 (see FIG. 5) on the interface 101 of the DatabaseWizard 100 and, in addition to a CollDbData-persistent parameter, a MapDbData-persistent parameter will be generated. The generated objects (DbBus, database-persistent parameter, CollDbData-persistent parameter, and/or MapDbData-persistent parameter) all are generated in a fully functional manner. At this point, however, the developer may wish to add custom functionality. For instance, the developer may want to add a custom property to the database-persistent parameter. It should be noted that, in the preferred embodiment, the generated code is placed in a separate folder. The generated code consists of base class files. The database-persistent parameter, the CollDbData-persistent parameter, the MapDbData-persistent parameter, and the DbBus object inherit from the generated base class files. It is useless for the developer to modify the generated base class files because any modifications will be overwritten upon the next build. However, the derived database-persistent parameter, etc. can be overwritten by a developer.

Business Objects can Inherit From Each Other

Inter-object inheritance with respect to the business objects is not the same type of inheritance that is understood in standard object oriented programming. Instead, inheritance for this aspect of the present invention is inheritance of database functionality, specifically columns/fields in the database 906 and is called business inheritance. For example, assume that a vessel is a type of transport. A developer can establish the relationship between vessel and transport in the DatabaseWizard 100. Upon subsequent use of the DatabaseWizard 100, the business object will be generated such that it contains all of the transport columns in the database as well as all of the vessel columns. Any call to create a vessel in the database will also create a transport in the database. The transport will contain a foreign key to the vessel. Updating of the database is similarly affected. Updating a vessel will update the vessel's associated transport. Deleting a vessel will delete the vessel's associated transport.

Business Objects can Convert to Other Business Objects

In the DatabaseWizard 100, a developer can indicate that two (or more) business objects are related. Moreover, the DatabaseWizard 100 can convert a particular business object into a business object of another type. When the business object is generated, it will contain functions that return a copy of the business object of the other type. The business object accomplishes the conversion by creating the business object of the other type, and then populating the new object (of the other type) with copies of its own data (properties). The caller of the function then receives the copy of the business object of the other type, fully populated with the same properties as the original business object. In the process of performing the conversion, the business framework 704 reviews the various columns in the database 908 that the business objects contain. For those columns that are the same (e.g., the same name and type) between the business objects are automatically copied between them. If the columns are different, they are not copied to the other business object. A developer can always override this default behavior and perform a copy between different columns, for example, if desired. Performing a conversion by comparing database columns has a positive side effect; developers are encouraged to give columns the same names and types if they perform the same function. Business objects that are converted to other business objects are called “tearoffs” of that first business object.

Old Database-Persistent Parameter

In some situations, business objects need to know how they were changed by past actions. The business framework 704 includes one or more status flags for each value of the business object. However, these status flags merely indicate that a value has changed. The status flags do not indicate what the previous value was. The present invention provides a mechanism for determining previous values of business objects. A developer merely need activate the “Old” database-persistent parameter checkbox 508 on the Database Wizard 100 (see FIG. 5). When the “Old DbData” checkbox 508 is checked, the database-persistent parameter that is generated contains another database-persistent parameter. This “other” database-persistent parameter is of the same type as the original database-persistent parameter. However, the other database persistent parameter contains the state of the database-persistent parameter before the change was made. After a “create” or an “update” command has issued, the other database-persistent parameter will be updated with the previous value.

Generates Bus Code

Like DbBus objects, business objects are also generated. Business objects typically do not have database-persistent parameter objects and CollDbData-persistent parameter objects. Only the business object itself and all its project files are generated.

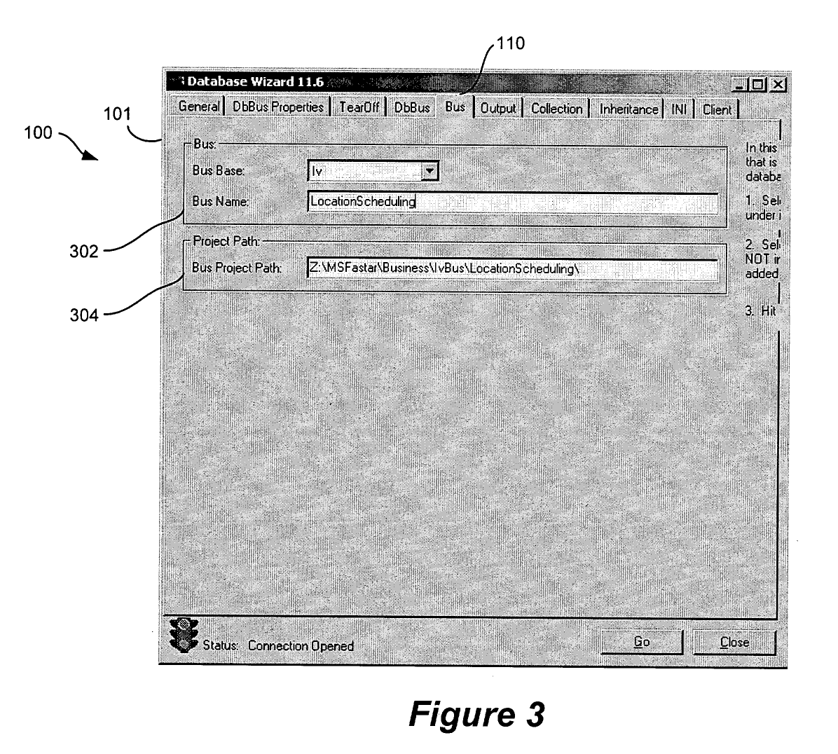

Illustrative parameters for the generation of business objects are shown in FIG. 3. The business tab 110 is selected to reveal optional parameters for the business objects. For instance the business object parameters 302 can be selected, such as the base class the name. The project path 304 may also be selected with the associated edit box as illustrated in FIG. 3.

Generates Client Code

Developers use the client tab of the DatabaseWizard 100 to generate, for example, user forms in the form of user classes. The generated client code (classes) will compile and can be used in executable binaries. Further, the DatabaseWizard 100 updates the hypertext markup language (“HTML”) page that the form uses so that it includes the generated form. The DatabaseWizard 100 can also generate dialogs that can also be added to the HTML pages.

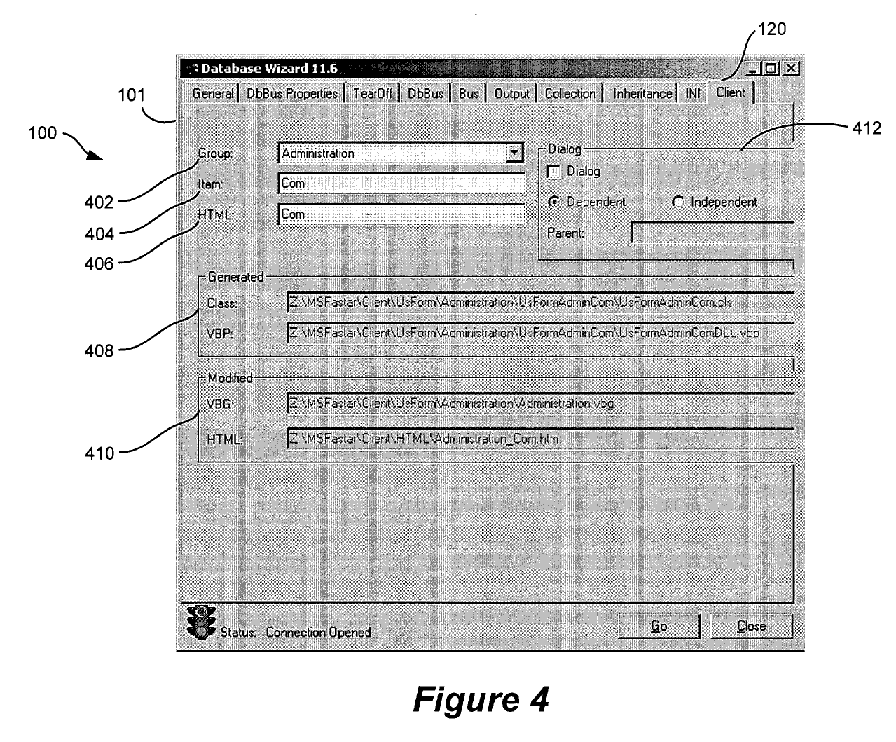

FIG. 4 illustrates the options for the client 902. The client tab 120 is selected to reveal various client-related parameters. For instance, the group parameter 402, the parameter 404 and the HTML parameter 406 can be selected or designated using the respective combo and edit boxes. Similarly, dialog-related information can be designated with the controls 412. Path (directory) information can be viewed/designated for generated cases 408 and modified cases 410.

Generates Stored Procedures

Stored Procedures are automatically generated, for instance, when the developer presses the “Go” button 512 on the database business (“DbBus”) properties tab 104 of the interface 101 of the DatabaseWizard 100 (see FIG. 5). However, on the DbBus properties tab 104, the developer can select more stored procedures to generate. The interface 101 of the DatabaseWizard 100 is useful for selecting one or more tables and views of the database 902 via the selection panel 502. Similarly, categories of properties may be selected by the controls 504. Automatic generation options may be selected by the controls 506. Retention of previous database values can be implemented via the control 508. Mapping (hash table) support is invoked via control 510.

The DatabaseWizard 100 generates various stored procedures for inserting, updating, deleting, selecting (such as select by primary key (“GetByPrimaryKey”) and list by all parameters (“ListByAll”) ). Because the DatabaseWizard 100 generates the stored procedures, the developer need not maintain those procedures. If the database schema changes, the developer merely needs to regenerate the business object, which the developer would have had to generate in any case for the business framework 704. The regeneration of the business object code will cause the stored procedures to be regenerated. If the developer has indicated that the table supports history, then the stored procedures will contain appropriate functionality to modify the history table. In the preferred embodiment, all tables automatically have the timestamp checking capability.

Generates Report Files

In the preferred embodiment, when a database business (DbBus) object is generated, the DatabaseWizard 100 will generate also generate a report (“TTX”) file. The report file allows integration with, for example CRYSTAL REPORTS, which is manufactured by Crystal Decisions, Inc. of Palo Alto, Calif. The TTX file tells CRYSTAL REPORTS the format of the data. This feature relieves the developer of the need to integrate the present invention with a third-party report program. The developer merely instructs the third party report program to reference the TTX file that was generated by the DatabaseWizard 100. Thereafter, the developer (or user) need only construct the report in the normal manner for use in conjunction with the third-party report program.

Generates XSD Files

The format of all data in the external framework 912 is described by an extensible Schema Definition (“XSD”). Each external client, therefore, has his own XSD file. The use of XSD's has many benefits. One benefit is that data can be validated against the XSD. Validation ensures that data coming into the external framework 912, or going out of the external framework 912, will be valid. The DatabaseWizard 100 provides help in generating XSD files for various business objects, typically from their database schema. If the database schema changes, then the DatabaseWizard 100 will ensure that the associated XSD files change as well. In some situations, because of the change of the XSD files, data may no longer validate. Consequently, it is recommended to invoke run-time checking to ensure that data is synchronized with the database 906.

Generating Batch Files

In the preferred embodiment, the DatabaseWizard 100 generates all of the necessary build batch files. By relying upon the DatabaseWizard 100 to generate the build batch files, the developer has an easy way to change the way that the builds are accomplished.

Starting the Build Process

Before a build, the DatabaseWizard 100 generates:

1. All base generated code. Generated code may not be placed in the version control system. Therefore, the DatabaseWizard 100 must generate all base code.

2. All code that does not already exist. Project make files and the like may not be placed in the version control system. Because make files are not in the version control system, they are generated instead. The generation of the make files gives the DatabaseWizard 100 the capability to change the project files for all business objects simply by changing the DatabaseWizard 100 code.

Because all of the base class files are generated (including the derived files), the developer only needs to place files in the version control system if the developer changes them. This means that the developer does not have to worry about checking in or checking out generated files. It also keeps the number of files in the version control system at a minimum. This is handy for developers who work from remote locations, and/or who have slow network connections.

The DatabaseWizard 100 is run as the first part of the build step to generate code before a build is necessary. The DatabaseWizard 100 is run first because:

1. Code that is not in the version control system must be generated for the object to build.

2. Generating code allows mass-update of project make files and other project-related files.

3. Generating batch files allows mass-update of the build environment.

4. Generating XSD files allows compile-time checking of database schema to XSD code.

5. Generating code allows compile-time checking of database schema to code. If, for instance, a database table has a column called volume. When the business object is generated for this table, the database-persistent parameter will have a method called get_Volume and put_Volume. Other business objects can then use the get_Volume and put_Volume methods. If the database table is then changed to remove the volume column column, then on subsequent regeneration, the base class will be missing the get_Volume, put_Volume methods. The other business objects that use the get_Volume and put_Volume methods now find them missing, and will subsequently fail to compile. Failure to compile will prompt corrective action on the part of the developer.

Enforces Naming Conventions

Enforcing naming conventions is a very important part of rapid application development. Enforced naming conventions enable the product to be simpler, easier to understand, and thus more maintainable. The DatabaseWizard 100 enforces naming conventions on the:

1. Business Framework 704. In the database business object (DbBus) tab 108 and business object (Bus) tab 110 of the DatabaseWizard 100, developers choose the group that their business object belongs to and the short name of the business object (see FIGS. 2 and 3, respectively). From the group and short name, a full name for the object is constructed. Developers cannot manually override the naming process and they cannot change the path to which the files are generated. The present invention thus forces all business objects to obey the same naming convention.

2. Client Framework 702. When developers use the client tab 120 of the DatabaseWizard 100, they can only enter a short name for an object (see FIG. 4). All other names (form, HTML, etc.) are then constructed from the short name. Thus, developers do not have the liberty to violate naming conventions imposed by the DatabaseWizard 100.

3. Database Framework 908. In the preferred embodiment, stored procedures follow a naming convention. If stored procedures do not obey a naming convention, the DatabaseWizard 100 will not generate code to allow them to be accessed. Moreover, if tables or views do not follow a naming convention, the DatabaseWizard 100 will not generate them. Enforcement of naming conventions ensures that tables and views follow a primary key design methodology and use user-defined types when appropriate.

4. External Framework 912. XSD's may also be generated from business objects. When XSDs are generated, they are generated such that they follow the XSD naming conventions. Because the external framework 912 uses these generated XSDs, the external framework 912 must also follow naming conventions as they apply to the XSD.

Enforces Database Schema Conventions

In the preferred embodiment, the tables and views of the database 906 may have a primary key (“PrimaryKey”). If the database table or view has a primary key, then the PrimaryKey value must be in a single column and it must be called “yOid” (according to the adopted convention of this example). In addition, the PrimaryKey column must have two other associated columns, namely: the user name (“UserName”) and the time stamp (“TimeStamp”) (according to the naming convention of this example). Consequently, if a database table or view has a primary key, then it will have at minimum three columns; one for the primary key and two columns that are not. The particular primary key convention is enforced by the DatabaseWizard 100.

The Deploy Wizard

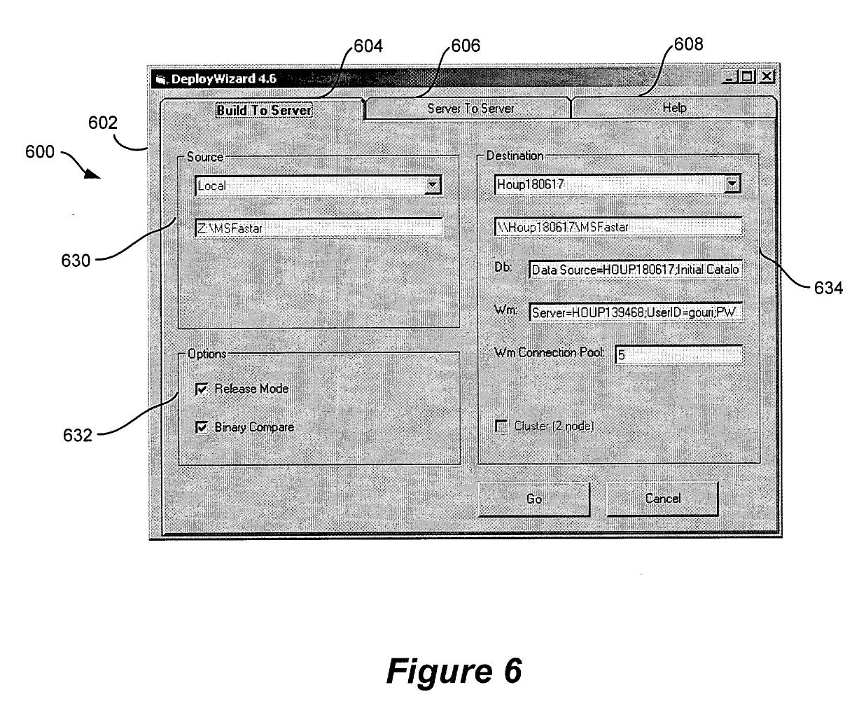

Deploying an n-tier enterprise application is not easy. The deployment can be made easier with a tool called the DeployWizard 600 (see FIG. 6). The DeployWizard 600 does much more then simply copying files from one server to another. Among other things, the user can instruct the DeployWizard 600 to deploy the software to a specific server at run time. Once instructed, the DeployWizard 600 can complete the deployment automatically.

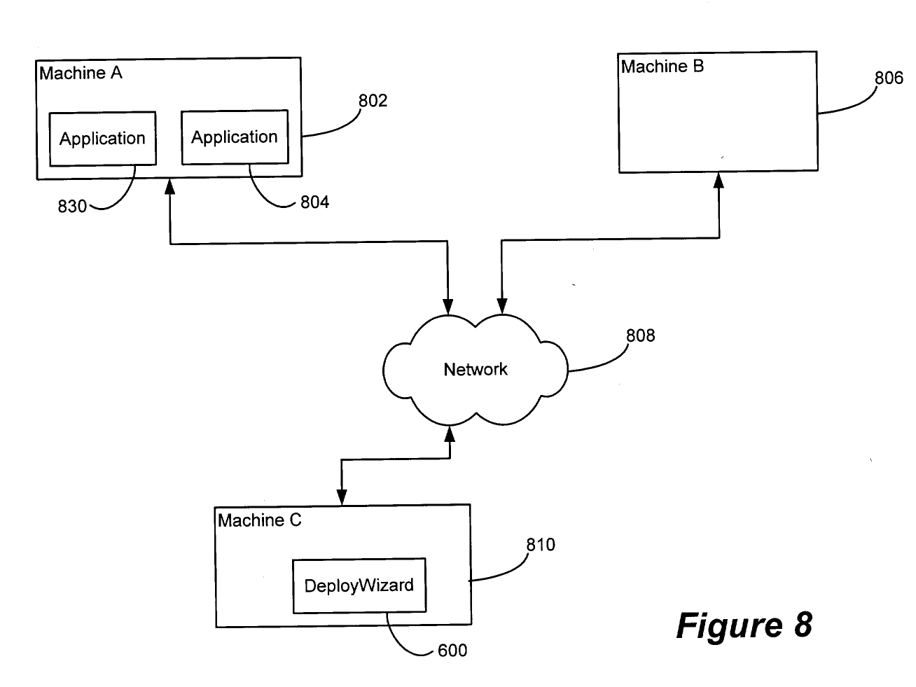

The DeployWizard 600 can have a GUI 602 (see FIG. 6). Alternatively, the DeployWizard 600 can be run from the command line by the user, or another process via an application program interface (“API”). The DeployWizard 600 is preferably designed to be run from any machine (e.g., client machine and/or server machine) within the network and operate correctly. For example, if the user wished to deploy an application 804 from machine “A” 802 to machine “B” 806 via the network 808, the DeployWizard 600 enables this to be accomplished from machine “C” 810 as illustrated in FIG. 8. The DeployWizard 600 interacts with a special component, the DeployHelper 830. The DeployHelper 830 is a component that is configured on the machine from which the application 804 is to be deployed. The DeployHelper 830 actually does the deployment work. The use of the DeployHelper 830 enables anyone on a development team to run the DeployWizard 600 without regard to the developer's location and that of the deployed machines.

The DeployWizard 600 facilitates rapid deployment of applications. Not only can deployment be done in one mouse click, but also the deployment strategy can be changed easily. Changes in deployment strategies merely require changes to the code of the DeployWizard 600 itself. The numerous business processes of the framework need not be modified, thus making the application independent of the deployment process.

An illustrative example of a graphical user interface (GUI) for the DeployWizard 600 is illustrated in FIG. 6. The DeployWizard 600 has an interface 602 with one or more tabs 604, 606 and 608 that provide specific functionality. For example, the tab 604 presents the user/developer with the ability to designate the source locations 630 of the application to be deployed. Similarly, the destination 634 may be designated by the user/developer using the edit boxes and combo boxes provided. Various options 632 may also be designated by the user/developer. Other information, such as server-to-server parameters are available through tab 606. Helpful information can be found at tab 608.

In the preferred embodiment of the present invention, the DeployWizard 600: creates a directory structure; copies files; registers files (if necessary); configures components; creates Cabinet (“CAB”) files (if necessary); compare binary versions (and update if necessary); and/or modify HTML pages. The following are detailed explanations of features of the preferred embodiment of the DeployWizard 600.

Create Directory Structure

The DeployWizard 600 ensures that the configuration for the destination machine is correct. If not, the DeployWizard 600 will change the destination configuration so that the configuration is functional. The DeployWizard 600 will create appropriate directory structures on the destination server if needed. Depending on whether or not the deployment overwrites an existing implementation, the DeployWizard 600 may also back up existing files, settings, etc. In the preferred embodiment, the DeployWizard's directory structure creation function is not highly configurable for a purpose. The lack of configuration flexibility forces deployed machines to be configured in the same manner, thus easing maintenance of the deployed applications.

Copy Files

Once the environment on the destination machine is correct, the DeployWizard 600 can copy all the binaries/scripts from development machine to production machine. Binaries will be placed in appropriate directories based on their function.

Register Files

After files are copied from one machine to another, they are registered on the target machine, if necessary.

Configure Components

The DeployWizard 600 handles the complexity of configuring all of the components inside, for example, a transaction server 904 (see FIG. 9). It is the configuration feature of the DeployWizard 600 that enables, for example, the business framework 704 to be transaction server neutral. The DeployWizard 600, therefore, is not transaction server neutral. The DeployWizard 600 must know about the transaction server 904 to which it is deploying so the DeployWizard 600 can configure components appropriately.

Create Cabinet (“CAB”) Files

The DeployWizard 600 packages all of the web files into Cabinet (CAB) files and automatically ensures that the CAB's are signed.

Compare Binaries

Binaries, such as binary executables, often have a version number. The version number indicates to the web browser whether the component is installed on the destination (user's) machine or not. If a component having the requisite version number (or higher) is not on the user's machine, the component will be downloaded from the server. The DeployWizard 600 can include a binary compare facility that can be used to ensure that components are downloaded only when necessary

In a normal development cycle, if a developer changes a component, then the developer must manually increment the component's version number. However, the DeployWizard 600 of the present invention can automate the incrementing of the component's version number. The DeployWizard 600, during deployment, performs a binary compare on new binaries against the old binaries. If the DeployWizard 600 detects a discrepancy in the binaries, the DeployWizard 600 will automatically update the version number of the new binary.

Modify HTML Pages

HTML pages can be used during development or be employed by users in a deployed environment. In development, HTML pages should not have a base tab, herein called a “codebase” tag. The codebase tag instructs the web browser to download the component. In a development machine, however, the component has already been installed on the machine. Therefore, all HTML pages do not include the codebase tag. Instead, the codebase tag is added at deploy time by the DeployWizard 600. After the DeployWizard 600 creates the CAB files, it modifies the HTML files to include the codebase tag which references the CAB files.

The Proxy Wizard

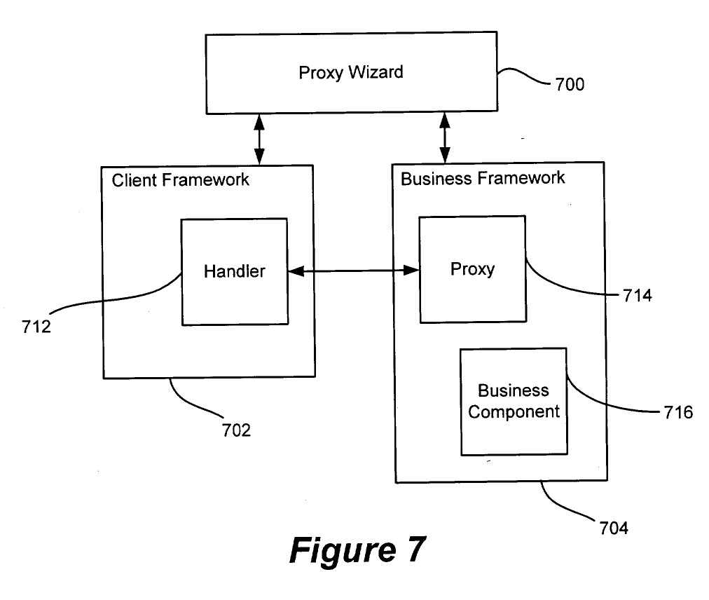

The ProxyWizard 700 generates code that is used to instantiate proxies and handlers. Referring to FIG. 7, proxies 714 are business objects that are exposed to the outside world. When external clients call into an enterprise application, they call into one or more proxies 714. An example of an enterprise application is business framework 704 and client framework 702. The proxies 714 ensure that certain security/transactional requirements are met. If the incoming signal satisfies the security/transactional requirements, then it passes the signal along to its intended destination by the proxy 714.

Handlers 712 are objects that are located on the client-side, such as the client framework 702. Handlers 712 are sometimes called stubs. All outgoing calls from a client (such as the client framework 702) go through a handler 712. The handler 712 determines the protocol to use for the outgoing call.

The ProxyWizard 700 automatically generates the code for proxies 714 and handlers 712. The code produced by the ProxyWizard 700 is then instantiated by another process/container, such as client framework 702. Whenever a business component 716 is built, particularly one that should be wrapped by a proxy 714, then the ProxyWizard 700 will be executed to generate the code for a new proxy 714 for the particular business component 716. In this way, the proxy 714 is built at the same time as the business object 716 that the proxy serves. The proxy 714 is intended (although not required) to have the same life-cycle as the object 716 for which it serves.

Because the code for the proxies 714 and handlers 712 are generated by the ProxyWizard 700 on an as-needed basis, the proxies 714 and handlers 712 are easy to enhance and to maintain. Rather than having to change all the proxy code manually, only the ProxyWizard 700 need be changed to implement modifications. Subsequently, when the ProxyWizard 700 is executed, it will generate the modified code. For example, it may be desirable to have the proxy 714 log the functions that are called by the business objects 716. With the present invention, all existing proxy code does not need to be manually modified. Instead, only the code within the ProxyWizard that generates the proxy code need be modified. Thereafter, when the ProxyWizard 700 executes, it will generate the proxy code such that it will perform the desired logging of function calls.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed is:

1. A toolset comprising:
a database wizard;
a deploy wizard; and
a proxy wizard;
wherein said wizards generate code to implement functionality for an application.

2. A database wizard method comprising:
generating DbBus code;
generating Bus code;
generating client code;
generating one or more stored procedures;
generating one or more TTX files;
generating one or more XSD files;
generating one or more batch files;
starting a build process;
enforcing one or more naming conventions; and
enforcing one or more database schema conventions.

3. A deploy wizard method comprising:
creating a directory structure;
copying one or more files;
registering said one or more files;
configuring one or more components;
creating at least one CAB;
comparing one or more binaries; and
modifying at least one HTML page.

4. A proxy wizard method comprising:
generating at least one proxy; and
generating at least one handler.

5. The method of claim 4, wherein said proxy is a business object.

6. The method of claim 4, wherein said handler is a client-side object.

7. The method of claim 5, wherein said proxy is exposed.

8. The method of claim 6, wherein said proxy accepts calls from one or more external clients.

9. The method of claim 6, wherein said handler handles outgoing calls.

10. The method of claim 9, wherein said handler determines which of one or more protocols is used for said outgoing calls.

11. The toolset of claim 1, wherein said application is a framework.

12. The toolset of claim 1, wherein said application is an enterprise application.

13. The toolset of claim 1, wherein said application is a multi-tiered enterprise application.

14. A framework comprising:
a transaction server;
a business framework within said transaction server;
a database operative with said transaction server;
a database framework within said database; and
a database wizard within said database;
wherein database wizard performs a function affecting said framework.

15. The framework of claim 14, wherein said function is the generation of code for a database business object for said business framework.

16. The framework of claim 14, wherein said function is the generation of code for a business object for said business framework.

17. The framework of claim 14, said framework further comprising:
a client framework operative with said transaction server, said client framework servicing at least one client through an interface.

18. The framework of claim 17, wherein said function is the generation of said interface.

19. The framework of claim 14, wherein said function is the generation of a stored procedure for said database.

20. The framework of claim 14, wherein said function is the generation of a report writing file.

21. The framework of claim 14, wherein said function is the generation of an XML schema definition file.

22. The framework of claim 14, wherein said function forms a portion of a build process.

23. The framework of claim 14, wherein said function is the enforcement of at least one naming convention.

24. The framework of claim 14, wherein said function is the enforcement of at least one database schema convention.

25. The framework of claim 15, wherein said database business object has a database-specific aspect.

26. The framework of claim 25, wherein said database-specific aspect is connected to a table of said database.

27. The framework of claim 25, wherein said database-specific aspect is connected to a view of said database.

28. The framework of claim 15, wherein said database business object has an external-specific aspect.

29. The framework of claim 28, wherein said external-specific aspect is connected to an external system.

30. The framework of claim 15, wherein said database business object has a database-persistent parameter.

31. The framework of claim 15, wherein said database business object has an external-persistent parameter.

32. The framework of claim 30, wherein a plurality of database business objects form a collection.

33. The framework of claim 32, wherein said collection is kept within a collection object.

34. The framework of claim 33, wherein said collection object has an interating algorithm.

35. The framework of claim 34, wherein said interating algorithm is a linked list.

36. The framework of claim 34, wherein said interating algorithm is a hash.

37. The framework of claim 31, wherein a plurality of database business objects form a collection.

38. The framework of claim 37, wherein said collection is kept within a collection object.

39. The framework of claim 38, wherein said collection object has an interating algorithm.

40. The framework of claim 39, wherein said interating algorithm is a linked list.

41. The framework of claim 15, wherein said database wizard has a graphical user interface.

42. The framework of claim 41, wherein said graphical user interface has a table locator, said table locator being constructed and arranged to find one or more tables within said database.

43. The framework of claim 41, wherein said graphical user interface has a view locator, said table locator being constructed and arranged to find one or more views within said database.

44. The framework of claim 41, wherein said graphical user interface has a table and view locator, said table and view locator being constructed and arranged to find one or more tables and one or more views within said database.

45. The framework of claim 42, wherein said graphical user interface enables the designation of a base class for said database business object.

46. The framework of claim 43, -wherein said graphical user interface enables the designation of a location where said generated code is placed.

47. The framework of claim 15, wherein said database business object is inherited from a generated base class.

48. The framework of claim 15, wherein said code is base code.

49. The framework of claim 15, wherein said code is derived code.

50. The framework of claim 48, wherein said base code includes a get function.

51. The framework of claim 48, wherein said base code includes a put function.

52. The framework of claim 48, wherein said base code includes a CloneNew function.

53. The framework of claim 48, wherein said base code includes a clone function.

54. The framework of claim 48, wherein said base code includes one or more status flags.

55. The framework of claim 48, wherein said base code includes support of one or more primitive types.

56. The framework of claim 48, wherein said base code includes one or more state types.

57. The framework of claim 48, wherein said base code includes support for business inheritance.

58. The framework of claim 48, wherein said base code includes support for object metamorphosis.

59. The framework of claim 48, wherein said base code includes a change history.

60. The framework of claim 49, wherein said base code includes a get function.

61. The framework of claim 49, wherein said base code includes a put function.

62. The framework of claim 49, wherein said base code includes a CloneNew function.

63. The framework of claim 49, wherein said base code includes a clone function.

64. The framework of claim 49, wherein said base code includes one or more status flags.

65. The framework of claim 49, wherein said base code includes support of one or more primitive types.

66. The framework of claim 49, wherein said base code includes one or more state types.

67. The framework of claim 49, wherein said base code includes support for inheritance.

68. The framework of claim 49, wherein said base code includes support for object metamorphasis.

69. The framework of claim 49, wherein said base code includes a change history.

70. The framework of claim 16, wherein said business object can create a clone of itself.

71. The framework of claim 70, wherein said business object has one or more persistent values.

72. The framework of claim 71, wherein said one or more persistent values are included when said business object is generated.

73. The framework of claim 72, wherein said one or more persistent values are cloned when said business object is cloned.

74. The framework of claim 70, wherein said business object has one or more non-persistent values.

75. The framework of claim 74, wherein said one or more non-persistent values are cloned when said business object is cloned.

76. The framework of claim 74, wherein said non-persistent values may be added to said business object by a developer.

77. The framework of claim 70, wherein said business object has one or more persistent values and one or more non-persistent values.

78. The framework of claim 77, wherein said one or more persistent values and said one or more non-persistent values are cloned when said business object is cloned.

79. The framework of claim 70, wherein said business object has one or more status flags.

80. The framework of claim 79, wherein said one or more status flags are cloned when said business object is cloned.

81. The framework of claim 80, wherein when said business object has been cloned to create a cloned business object, one or more of said status flags of said cloned business object are reset.

82. The framework of claim 82, wherein said cloned business object has a unique primary key in said database.

83. The framework of claim 16, wherein said business object has a get function to retrieve one or more persistent values of said business object.

84. The framework of claim 16, wherein said business object has a put function to store one or more persistent values of said business object.

85. The framework of claim 16, wherein said business object has one or more database-persistent parameters.

86. The framework of claim 85, wherein each of said one or more database-persistent parameters has a status flag.

87. The framework of claim 16, wherein said business object has one or more external-persistent parameters.

88. The framework of claim 87, wherein each of said one or more external-persistent parameters has a status flag.

89. The framework of claim 86, said framework further comprising:
a Process, said Process constructed and arranged to inspect said status flags of said business objects.

90. The framework of claim 89, wherein said Process is constructed and arranged to perform an operation with said database-persistent parameter as a function of a status of said business object.

91. The framework of claim 89, wherein said Process is generated.

92. The framework of claim 14, wherein said database comprises:
one or more tables, said tables having one or more columns.

93. The framework of claim 92, wherein said one or more columns is a primary key.

94. The framework of claim 92, wherein said one or more columns is a calendar.

95. The framework of claim 92, wherein said one or more columns is unit.

96. The framework of claim 92, wherein said one or more columns is a database indicator.

97. The framework of claim 92, wherein said one or more columns is a binary file.

98. The framework of claim 93, wherein a wrapper object is generated for said primary key by said database wizard.

99. The framework of claim 94, wherein a wrapper object is generated for said calendar by said database wizard.

100. The framework of claim 95, wherein a wrapper object is generated for said unit by said database wizard.

101. The framework of claim 96, wherein a wrapper object is generated for said database indicator by said database wizard.

102. The framework of claim 97, wherein a wrapper object is generated for said binary file by said database wizard.

103. The framework of claim 14, wherein said database contains at least one database element.

104. The framework of claim 103, wherein said database element is a table.

105. The framework of claim 103, wherein said database element is a view.

106. The framework of claim 103, wherein a business object is generated from said database element by said database wizard.

107. The framework of claim 106, wherein said database wizard is constructed and arranged to generate one or more business object states.

108. The framework of claim 107, wherein said database wizard is further constructed and arranged to generate a collection object of said business object states.

109. The framework of claim 108, wherein said collection object has a search mechanism.

110. The framework of claim 109, wherein said search mechanism is a linked list.

111. The framework of claim 103, wherein said database wizard is constructed and arranged to generate:
a business object, said business object being generated from said database element;
one or more business object states; and
a collection object of said business object states.

112. The framework of claim 111, wherein said business object, said one or more business object states, and said collection object are fully-functional as generated.

113. The framework of claim 111, wherein a developer may add one or more database-persistent parameters after generation by said database wizard.

114. The framework of claim 16, wherein said business object is constructed and arranged to facilitate inter-object inheritance.

115. The framework of claim 114, wherein said inter-object inheritance includes inheritance of database functionality.

116. The framework of claim 115, wherein said database functionality includes one or more columns within said database.

117. The framework of claim 114, wherein said inter-object inheritance establishes a relationship between two or more of said business objects.

118. The framework of claim 16, wherein each of said business objects has a type.

119. The framework of claim 118, wherein said database objects are constructed and arranged to facilitate conversion from a first of said type to a second of said type.

120. The framework of claim 85, wherein said business object includes a database past persistent parameter that contains a previous value of another database-persistent parameter.

121. The framework of claim 17, wherein said function is the generation of code for said client.

122. The framework of claim 14, wherein said function is the generation of one or more stored procedures for said database.

123. The framework of claim 14, wherein said function is the generation of one or more report files.

124. The framework of claim 14, wherein said function is the generation of one or more extensible schema definition files.

125. The framework of claim 14, wherein said function is the generation of one or more batch files.

126. The framework of claim 14, wherein said function is the commencement of a build process.

127. The framework of claim 126, wherein said build process generates base generated code.

128. The framework of claim 14, wherein said function is the enforcement of at least one naming convention.

129. The framework of claim 14, wherein said function is the enforcement of at least one database schema convention.

130. A toolset comprising:
a deploy wizard;
wherein said deploy wizard facilitates the deployment of an application.

131. The toolset of claim 130, wherein said deploy wizard is constructed and arranged to copy files.

132. The toolset of claim 131, wherein said deploy wizard is constructed and arranged to copy said files to a server at a pre-selected time.

133. The toolset of claim 130, wherein said deploy wizard has a command line interface.

134. The toolset of claim 130, wherein said deploy wizard has a graphical user interface.

135. The toolset of claim 130, wherein said deploy wizard can be executed from any machine on a network.

136. The toolset of claim 130, wherein said deploy wizard has a DeployHelper component.

137. The toolset of claim 130, wherein said deploy wizard has a deployment strategy.

138. The toolset of claim 137, wherein said deployment strategy is selected by a user.

139. The toolset of claim 137, wherein said deployment strategy can be changed.

140. The toolset of claim 130, wherein a user can designate a source location.

141. The toolset of claim 130, wherein a user can designate a destination location.

142. The toolset of claim 134, wherein a source location may be designated with said graphical user interface.

143. The toolset of claim 134, wherein a destination location may be designated with said graphical user interface.

144. The toolset of claim 134, wherein one or more server-to-server parameters may be designated with said graphical user interface.

145. The toolset of claim 133, wherein said deploy wizard is constructed and arranged to:
create a directory structure;
copy one or more files;
configure one or more components; and
compare at least one binary version to a requisite version.

146. The toolset of claim 145, wherein said deploy wizard is further constructed and arranged to:
register one or more files.

147. The toolset of claim 145, wherein said deploy wizard is further constructed and arranged to:
create one or more Cabinet files.

148. The toolset of claim 145, wherein said deploy wizard is further constructed and arranged to:
update said binary version.

149. The toolset of claim 145, wherein said deploy wizard is further constructed and arranged to:
modify one or more HTML pages.

150. A toolset comprising:
a proxy wizard;
wherein said proxy wizard performs a function to facilitate an enterprise application.

151. The toolset of claim 150, wherein said function is the generation of code.

152. The toolset of claim 151, wherein said code is a proxy.

153. The toolset of claim 151, wherein said code is a handler.

154. The toolset of claim 152, wherein said proxy wizard instantiates said proxy.

155. The toolset of claim 153, wherein said proxy wizard instantiates said handler.

156. The toolset of claim 152, wherein said proxy ensures that at least one security requirement is satisfied.

157. The toolset of claim 152, wherein said proxy ensures that at least one transaction requirement is satisfied.

158. The toolset of claim 153, wherein said handler is constructed and arranged to handle an outgoing call from a client.

159. The toolset of claim 152, wherein said proxy is instantiated by a framework.

160. The toolset of claim 152, wherein a business object is generated at the same time as said proxy.

161. The toolset of claim 152, wherein if said proxy wizard is modified, then all proxies generated by said proxy wizard are also modified.

162. The framework of claim 42, wherein said graphical user interface enables the designation of an organizational group for said database business object.

163. The framework of claim 109, wherein said search mechanism is a hash.

164. A database wizard method comprising:
generating DbBus code;
generating Bus code;
generating client code;
generating one or more stored procedures;
generating one or more batch files; and
starting a build process.

165. The method of claim 164 further comprising:
generating one or more TTX files.

166. The method of claim 164 further comprising:
generating one or more XSD files.

167. The method of claim 164 further comprising:
enforcing one or more naming conventions.

168. The method of claim 164 further comprising:
enforcing one or more database schema conventions.

169. A deploy wizard method comprising:
copying one or more files;
registering said one or more files;
configuring one or more components; and
creating at least one CAB.

170. The method of claim 169 further comprising:
creating a directory structure.

171. The method of claim 169 further comprising:
comparing one or more binaries.

172. The method of claim 169 further comprising:
modifying at least one HTML page.
